(19) United States
(12) Patent Application Publication
(10) Pub. No.: US 2008/0042831 A1
(43) Pub. Date: Feb. 21, 2008

(54) Surveillance Device and Installation in Particular for Domestic Property

(75) Inventors: Johnny Allia, Nice (FR); Olivier Chantelou, Nice (FR); Francois Kaag, Nice (FR); Gerard Langlois, Nice (FR)

Correspondence Address: YOUNG & THOMPSON, 745 SOUTH 23RD STREET, 2ND FLOOR, ARLINGTON, VA, 22202, US

(73) Assignee: SECURITE COMMUNICATIONS, VALBONNE (FR)

(21) Appl. No.: 11/794,895

(22) PCT Filed: Jan. 5, 2006
(86) PCT No.: PCT/EP06/50057

§ 371 Date: Jul. 9, 2007

(30) Foreign Application Priority Data
Jan. 10, 2005 (FR) 0550075

(51) Int. Cl. G08B 13/00

(52) U.S. Cl. 340/541

(57) ABSTRACT

The invention relates to a surveillance device for installation in a domestic property, comprising event execution means and processing means for generation of commands for at least one event reaction body, characterised in comprising a network (6) of cooperating non-hierarchical modules (1,2,3,4), each comprising detection data processing means (8) and internal communication means (9), configured for exchange of surveillance data between modules. The invention further relates to a surveillance installation comprising several such devices.

This invention relates to a surveillance device that is able to be installed in a real estate property.

It also relates to a surveillance installation that is able to comprise several devices according to the invention.

The invention finds its application in the field of transmitting surveillance data, and in particular for the security of real estate properties, be they commercial or industrial premises, detached homes or joint-ownership properties.

The invention also has applications beyond security that concern in particular the transmitting or receiving of surveillance information for operating devices or machines.

Within the scope of installing alarms, traditionally a number of detecting means (such as infrared detectors, door-opening detectors, motion detectors, cameras, etc.) connected to a central unit that can process information received from detectors and produce the suitable reaction are used.

The central unit makes possible in particular the retransmission of events detected via available networks, such as the telephone line, the voice GSM (for global system for mobile communication), GSM data, GPRS (for general packet radio service), and SMS (for short message service).

The choice of network is made by successive tests in a predefined sequence.

Thus, according to the current state of the art, all of the data obtained from the detectors is concentrated toward the central unit that carries out all the stages of processing, retransmission and reaction to events.

The drawback of such a configuration is that it requires the implementation of a complex central unit because it carries out numerous operations.

The design of this central unit is expensive and generally not very scalable; it thus is not easy to retrofit a new specific means of transmission.

It then is necessary to dismantle the central unit, integrate the new element, reassemble it and reconfigure it and even replace the entire central unit.

On the security level, the presence of such a central unit makes the system more vulnerable in that said central unit constitutes the nerve center of the security installation.

Its neutralization destroys the entire surveillance installation.

The document DE-A1-19700716 is part of this framework in that it proposes a design for very complex alarm stations. To overcome the lack of reliability of prior systems, this document only proposes a redundancy of functions of an alarm central unit in each of the alarm stations that communicate in a synchronized way. Actually, this system only multiplies the number of complex elements of the installation, which greatly increase the cost.

EP-A1-1244081 also describes a conventional system that is hierarchized with a main control unit and stations. When a transmission between one station and the main unit is no longer possible, other elements relay the information. The case occurs only during failures and does not impair the hierarchized operation of the system.

US-A1-2004/0224713 finally shows a hierarchized system with a central station and peripherals organized in a network around the central unit. This system is greatly hierarchized.

This invention has as its object to remedy entirely or partially the drawbacks of the devices that are currently known.

To do this, it has a new surveillance device provided with a set of modules organized in a network, each comprising means for processing detection data and means for communication so as to exchange surveillance data between them.

The device is thus constituted in a modular way, i.e., the functionalities that are generally assigned to the central unit are distributed in various modules.

The unit is thus more scalable to the extent that it is enough to add or to replace a module to modify the technical configuration of the entire installation.

Furthermore, each of the modules used in the network can be of a standardized type that makes it possible to reduce the production costs and easily to constitute a complete surveillance device by standard combination of different types of modules.

On the level of security, it should be noted that even in the case of impairment or neutralization of one or more modules, the remainder of the network of modules continues to operate, which ensures continuation of the surveillance.

Other objects and advantages will emerge during the following description of a preferred embodiment of the invention which is not, however, limiting.

This invention relates to a surveillance device that can be installed in a real estate property, comprising means for detecting events and processing means able to generate commands of at least one reaction element to events, characterized by the fact that it comprises a network of cooperating and non-hierarchized modules each comprising means for processing detection data and means for internal communication configured to exchange surveillance data between the modules.

This device can come in the advantageous embodiments set forth below:
Entirely or partially, reaction means are each integrated in a module.
Entirely or partially, detection means are each integrated in a module.
The surveillance data exchanged by the modules comprise:
The data for detecting events;
The surveillance context data giving information about the modules as to the operating parameters of the device.
The surveillance data comprise data relative to the record of the operation of the device.
The detection data and the surveillance data are incorporated in a unique flow of transmission between the modules, and the transmission of said flow is performed synchronously, with each new event.
The means of internal communication are an emitter/receiver element with radiofrequency installed in each module.
The means of reaction comprise a siren.
The reaction means comprise means for transmitting reliable alert information on events, context or record, to an external communication network.
The processing means comprise a processor and means for storing instructional data able to process the detection data and the surveillance data.
At least one module comprises an audio or video sensor and means of transmitting video or audio streams that can be connected to an external communication network.

The invention also relates to a surveillance installation that comprises at least two devices according to the invention and each module network is connected to a bridge element that can connect each module network to an external communication network.

According to a preferred variant, this installation is such that the external communication network is a broad-scale computer network or a computer network carried over the power grid of the real estate property.

Advantageously, the modules transmit data in an asynchronous way. The transmission is triggered upon the occurrence of an event. The communication is thus simpler, more flexible and more reactive.

The attached drawing is given by way of example and does not limit the invention. It represents only one embodiment of the invention and will allow it to be easily understood.

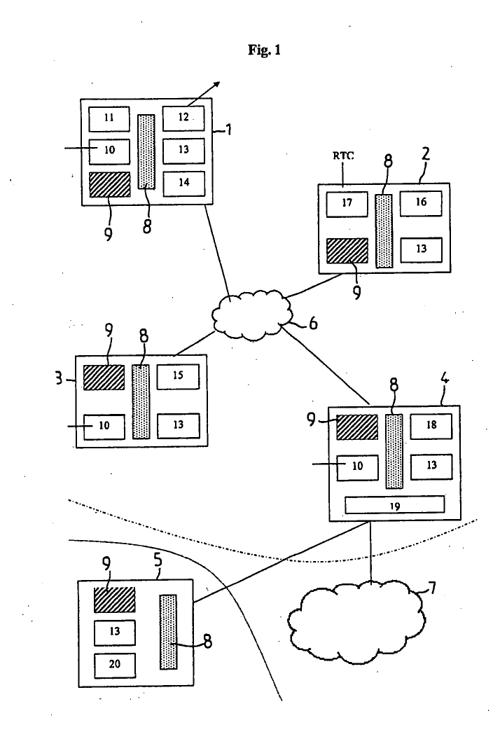

FIG. 1 shows an example of implantation of an installation according to the invention that uses two surveillance devices of simplified configuration.

As presented in FIG. 1, different modules 1, 2, 3, and 4 are organized in network 6 in particular by means of internal communication 9 that are present in each of the modules and that carry out a data exchange between the modules 1, 2, 3, and 4 by radio connection.

Thanks to this inter-module communication, the modules can exchange surveillance data there that generally comprise data relative to the events detected by detection means and surveillance context data.

These context data indicate to the modules the kind of interaction that they should maintain.

They also indicate to the module what the record is of the actions of the system.

The context gives information to the module in particular on the operating parameters of the device (as part of the active or inactive installation, value to be provided to the operational variables of the system, in particular the time values according to which a reaction should be performed following the detection of an event, etc.).

The modules also exchange the detection data that are the data that are obtained from detection means that can be carried out commonly in particular in the form of audio detector (microphone, video (camera), infrared detector, or any other known detector).

Thus, the different modules are informed of the events that are produced in the remainder of the device even if they are located at a spot removed from the detection means having to detect the event.

The communication between the modules 1, 2, 3, and 4 also ensure, if necessary, a data flow traffic that can then be sent back to an external communication network (telephone line, GSM, GPRS, SMS, etc.).

This flow traffic makes possible in particular remote audio and video surveillance.

The flow traffic can be supported by the communication means between the modules or by another connection between the modules or some of the modules, in particular by a hard-wire connection.

In the case illustrated in FIG. 1, the detection means are integrated in the modules 1, 2, 3, and 4.

However, it may also be a matter of remote elements that communicate in particular by radio in the form of peripherals with the modules 1, 2, 3, and 4.

In this case, several modules 1, 2, 3, and 4 can receive the radio message that is obtained from a detection peripheral.

The protocol for cooperation between the modules 1, 2, and 3 then includes a mechanism for eliminating duplicates.

In addition, a module can process an event received by means of intermodule exchanges via the means of communication even if it has not seen or received directly the detection data obtained from the detection means.

Thus, the modules act as relays for each other.

The modules do not comprise, however, a simple relay for data obtained from other modules. They share a data flow defining a single operating state that is common to all the modules 1, 2, 3, and 4. Each module 1, 2, 3, and 4 knows at each instant the complete state of the system by way of information received and duplicated.

As indicated above, each module 1, 2, 3, and 4 comprises processing means essentially in the form of a processor and a memory (in particular read-only memory and random access memory) that can support computer instructions for processing various data and exchange and detection streams.

Each module 1, 2, 3, and 4 has its own strategy for processing all the events.

This strategy is designed in particular to ensure the transmission of intrusion elements when even the connection between the modules 1, 2, 3, and 4 would be broken.

If this happened, the only risk would be to have several transmissions via different modules from the same event.

It is therefore enough to program specifically each module so that it maintains the strategy of processing desired data. So as to reduce the occurrence of multiple transmissions, the device can be configured so that one of the modules has priority for the external transmission of events, whereby the other modules only carry out the transmission if the “priority” module transmits to them a request for transmission or it is no longer linked to the other modules. Thus, according to the invention, the device is more certain than existing systems that are organized around a central unit, in the sense where it continues to operate and to transmit alerts as long as at least one of the modules is operational.

The protocol for cooperation between the modules 1, 2, 3, and 4 is conveyed by the communication means here that are preferably in the form of radio connections.

Regarding the transmission of data toward the outside of the device, reliable means for transmitting alert information to an external communications network that can take on different common shapes are advantageously used.

The transmission means are implemented in a module so as to preserve the modular aspect of the unit.

Thus, the module 1 comprises transmission means GPRS 12 that can retransmit the data obtained from the device to the standard external network.

Likewise, module 2 comprises a means for modem-type transmission (modulator/demodulator) for a retransmission to the switched telephone network (RTC) via a telephone interface 17.

Still by way of example, the module 3 comprises transmission means GSM for retransmitting the data to this network.

As for module 4, it comprises a communication bus 19 that communicates with an external communication network 7 in particular in the form of a broad-scale internet-type network.

Of course, other transmission means can be provided in other modules.

On the contrary, it is not necessary to use all the means of transmission shown in FIG. 1 so that the system is operational.

In particular, a simple GSM connection can be implemented.

In addition, certain modules cannot comprise transmission means.

During the operation of the device, it is the module 1, 2, 3, 4 that is responsible for the transmission to the outside that becomes the administrator of the flow exchanged between the modules.

A single module can be an administrator of the flow at a given movement.

In contrast, this role can be reassigned dynamically to another module according to the detection record.

In a general way, the modules 1, 2, 3, 4 have a battery 13 that allows them to operate independently.

According to the nature of on-board electric and electronic equipment and the necessary power supply, a supply sector can also be provided by means of a supply 10.

In the case illustrated in FIG. 1, two devices are formed.

One of the devices comprises the network of modules 1, 2, 3, and 4.

The other device is formed by or comprises the module 5.

Each device is assigned to the surveillance of a real estate property, for example two apartments of the same building.

Within this framework, the devices that constitute the installation of the complete building share the same network 7, for example such as Ethernet or broad-scale Internet.

In the illustrated case, each apartment comprises a module (4, 5) that ensures the bridge function, among other functions.

In particular, in addition to the processing means 8, the module 5 comprises means for communication 9, a battery 13, and a siren 20.

It is possible in this way to carry out a simplified installation for several sets of apartments of a building.

Actually, the latter share the same external network 7.

Below, an example of the administration of events within the framework of a device of the type of the one that is illustrated with the modules 1, 2, 3, and 4 is described.

Within this framework, the modules share:
A set of events whose duration is limited. A life cycle and qualifiers, i.e., data describing the attributes of the event, are associated with each event. For example, one of these qualifiers is the stage in the life cycle.
A set of contexts (the contexts are lengthy data).
A record or common journal with a uniform dating.

Each event, moreover, belongs to one or more groups of events, independent of the context of the installation. Groups are, in particular:
The set of events obtained from the same peripheral
The set of events with the same meaning: battery failure, self-protection, intrusion, request for start-up, etc.
When a peripheral takes on several functions, the set of events of this peripheral suitable for this function.
Etc.

Each module has a processing scenario for each event. This scenario comprises, for each stage of the life cycle of the event, a processing script linking elementary actions.

One of the elementary actions is the proposal of a next stage for the event. When all the modules that are present have completed their scripts for the current stage, the event is re-qualified with the highest value of the stages proposed by the set of scripts per stage.

The following commands are typical elementary actions:
WAIT(T)
   Wait for a given time
SEND_ALERT (COMM_PARAMS,LABEL)
   Attempt transmission and proceed to another action in case of failure
RAISE (EVT)
   Create a new event
TEST_QUALIFY (CONDITION, LABEL)
   TEST_CONTEXT (CONDITION, LABEL)
      Proceed to another action of the script according to a qualifier or a context
SET_CONTEXT (CONTEXT, VALUE)
   Position a shared variable of the context
RECORD_LOG (LOGLINE)
   Record a journal line
DRIVE(OUT_LINE)
   Control an actuator (actually will be processed by the administrator of the flows of the addressed component)
WAIT_EVENT (T, EVENT, LABEL)
   Wait for another event (or group) for a maximum time
WAIT_QUALIFY (T, STEP)
   WAIT_CONTEXT (T, CONDITION, LABEL)
   Wait for a condition for a maximum time
PROPOSE_STEP(STEP)
   Propose a next step. The proposal having the highest value will be maintained at the end of implementing all of the scripts.

Use Case—Timed Detector

It is a detector whose detection will create a transmission at the end of 20 seconds if the zone of the surveillance network to which it belongs is not disarmed in time.

In this example, there will be, in the case where the transmission of the alert fails, a second attempt to another telephone number.

TABLE 1

| Stage | MODULE |
|---|---|
| 1 | TEST_CONTEXT (Armed Zone, Detection) |
| | PROPOSE_STEPS (5) |
| | Detection: |
| | SET_CONTEXT (Time of Entry) |
| | PROPOSE_STEP (2) |
| 2 | WAIT_CONTEXT |
| | (20 Seconds, Disarmed Zone, Intrusion) |
| | PROPOSE_STEP (5) |
| | Intrusion: |
| | PROPOSE_STEP (3) |
| 3 | SEND ALERT (Telephone Number 1, Fail) |
| | PROPOSE_STEP (5) |
| | Fail: |
| | PROPOSE_STEP (4) |
| 4 | SEND ALERT (Telephone Number 2, Fail) |
| | PROPOSE_STEP (5) |
| | Fail: |
| | PROPOSE_STEP (5) |
| 5 | DONE |

Use Case—Mixed Detector

It is a detector whose detection causes an immediate transmission if it is triggered first, and a delayed transmission if it is triggered according to a timed detector.

TABLE 2

| Stage | MODULE |
|---|---|
| 1 | TEST_CONTEXT (Time of Entry, Delayed) |
| | PROPOSE_STEP (3) |
| | Delayed: |
| | TEST_CONTEXT (Armed Zone, Inactive) |
| | PROPOSE_STEP (2) |
| | Inactive: |
| | PROPOSE_STEP (4) |
| 2 | WAIT_CONTEXT |
| | (20 Seconds, Activated Zone, Disarmed) |
| | PROPOSE_STEP (3) |
| | Disarmed: |
| | PROPOSE_STEP (4) |
| 3 | SEND ALERT (Telephone Number, Fail) |
| | PROPOSE_STEP (4) |
| | Done: |
| | PROPOSE_STEP (4) |
| 4 | DONE |

Use Case—Timed Detector with Image and Sound

This is a motion detector with an integrated photo device, located in the input. After its triggering, the user has 20 seconds to disarm the zone. In the contrary case, the alarm is sent, followed by a transfer of images by GPRS and listening on the telephone line.

The system comprises:
A motion detector module/photo device/GPRS transmitter
A telephone transmitter module

The initial event is the detection by the motion detector. Its life cycle is as follows:

1. Decision noted [symbol] 2 or 6

2. Disarming delay [symbol] 3 or 6

3. Transmission of the alert by GPRS [symbol] 4 or 5

4. Transmission of the alert by RTC [symbol] 5 or 6

5. Transmission of the image by GPRS and the audio by RTC

6. End of processing

The scenarios of the two modules are as follows:

TABLE 3

| Stage | RTC Transmitter | GPRS Transmitter |
|---|---|---|
| 1 | TEST_CONTEXT (Armed Zone, | TEST_CONTEXT (Armed |
| | Detection) | Zone, Detection) |
| | PROPOSE_STEP (6) | PROPOSE_STEP (6) |
| | Detection: | Detection: |
| | SET_CONTEXT (Time of Entry) | SET_CONTEXT (Time of |
| | PROPOSE_STEP (2) | Entry) |
| | | PROPOSE_STEP (2) |
| 2 | WAIT_CONTEXT | WAIT_CONTEXT |
| | (20 Seconds, Disarmed Zone, | (20, Disarmed Zone, |
| | Intrusion) | Intrusion) |
| | PROPOSE_STEP (6) | PROPOSE_STEP (6) |
| | Intrusion: | Intrusion: |
| | PROPOSE_STEP (3) | PROPOSE_STEP (3) |
| 3 | PROPOSE_STEP (4) | SEND_ALERT (IP |
| | | Address, Fail) |
| | | PROPOSE_STEP (5) |
| | | Fail: |
| | | PROPOSE_STEP (4) |
| 4 | SEND_ALERT (Telephone | PROPOSE_STEP (5) |
| | Number, Fail) | |
| | PROPOSE_STEP (5) | |
| | Fail: | |
| | PROPOSE_STEP (6) | |
| 5 | OPEN_STREAM (Telephone | OPEN_STREAM (IP |
| | Number, Audio) | Address, Images) |
| | WAIT_EVENT (Hung up, | WAIT_EVENT (Hung up, |
| | 3 Minutes) | 2 Minutes) |
| | PROPOSE_STEP (6) | PROPOSE_STEP (6) |
| 6 | DONE | DONE |

The preceding cases indicate different examples of configuration of the network of modules, the exchange of information produced between the modules as well as the processing of detection data.

It thus is clearly noted that the modules are both able to operate with processing and an autonomous reaction following a detection of events and sharing information to envisage other reactions (transmission, siren, etc.) with other modules.

The unit is thus both collective but preserves individual administration within the modules . . .

### REFERENCES

1, 2, 3, 4. Modules
5. Module
6. Network
7. External Communication Network
8. Processing Means
9. Communication Means
10. Supply
11. Camera
12. GPRS Transmission Means
13. Battery
14. Infrared Detector
15. GSM Transmission Means
16. Modem Transmission Means
17. Telephone Interface
18. Audio Detector
19. Communication Bus
20. Siren

1. Surveillance device that can be installed in a real estate property, comprising means for detecting events and processing means able to generate commands of at least one reaction element to events, characterized by the fact that it comprises a network (6) of cooperating and non-hierarchized modules (1, 2, 3, 4) each comprising means for processing (8) detection data and means for internal communication (9) configured to exchange surveillance data between the modules.

2. Device according to claim 1, wherein all or part of the reaction means are each integrated in a module (1, 2, 3, 4).

3. Device according to claim 1, wherein all or part of the detection means are each integrated in a module (1, 2, 3, 4).

4. Device according to claim 1, wherein the surveillance data exchanged by the modules (1, 2, 3, 4) comprise: the data of detection of events; surveillance context data providing information to the modules as to the operating parameters of the device.

5. Device according to claim 4, wherein the surveillance data comprise data relative to the record of operation of the device.

6. Device according to claim 4, wherein the detection data and the surveillance data are incorporated in a single transmission flow between the modules and wherein the transmission of said flow is performed in a synchronous way with each new event.

7. Device according to claim 1, wherein the internal communication means (9) are an emitter/receiver element with radiofrequency that is implanted in each module (1, 2, 3, 4).

8. Device according to claim 1, wherein the reaction means comprise a siren.

9. Device according to claim 1, wherein the reaction means comprise means for transmitting reliable alert information on events, context or record, to an external communication network (7).

10. Device according to claim 1, wherein the processing means (8) comprise a processor and means for storing instructional data able to process the detection data and the surveillance data.

11. Device according to claim 1, wherein at least one module (1, 2, 3, 4) comprises a reliable audio or video sensor and means of transmitting video or audio streams that can be connected to an external communication network.

12. Surveillance installation, wherein it comprises at least two devices according to claim 1 and wherein each network of modules (1, 2, 3, 4, 5) is connected to a bridge element that can connect each network of modules to an external communication network.

13. Installation according to claim 12, wherein the external communication network is a broad-scale computer network or a computer network carried over the power grid of the real estate property.

14. Device according to claim 2, wherein all or part of the detection means are each integrated in a module (1, 2, 3, 4).

15. Device according to claim 2, wherein the surveillance data exchanged by the modules (1, 2, 3, 4) comprise: the data of detection of events; surveillance context data providing information to the modules as to the operating parameters of the device.

16. Device according to claim 3, wherein the surveillance data exchanged by the modules (1, 2, 3, 4) comprise: the data of detection of events; surveillance context data providing information to the modules as to the operating parameters of the device.

17. Device according to claim 5, wherein the detection data and the surveillance data are incorporated in a single transmission flow between the modules and wherein the transmission of said flow is performed in a synchronous way with each new event.
